(19) United States
(12) Patent Application Publication
(10) Pub. No.: US 2018/0224539 A1
(43) Pub. Date: Aug. 9, 2018

(54) PORTABLE ENCLOSED SPEED LIMIT RADAR

(71) Applicant: Olivier Pouille, Riviera Beach, FL (US)

(72) Inventor: Olivier Pouille, Riviera Beach, FL (US)

(21) Appl. No.: 15/426,788

(22) Filed: Feb. 7, 2017

(51) Int. Cl. G01S 13/86; G01S 13/58; G01S 7/00; H04N 7/18; H04N 5/33; H04N 5/232; H04N 5/225

(52) U.S. Cl. CPC G01S 13/867; G01S 13/58; G01S 7/003; G01S 2007/027; H04N 5/33; H04N 5/23245; H04N 5/2257; H04N 7/183

(57) ABSTRACT

A portable enclosure for a speed limit video radar is provided. Several parts are integrated into a single portable enclosure, which may include a camera, a radar, a network module, a rechargeable battery and one or more processors. The portable enclosure may be mountable to a standard tripod. The network module may connect to a cellular network to upload video footage of potential violations into a centralized remote cloud storage. Optionally, a GPS receiver may be integrated to provide device location tracking and geotagging. For device management and configuration, the network module may expose a wireless network, which may connected to using a mobile device such as a smartphone or tablet.

### BACKGROUND OF THE INVENTION

The present invention generally relates to surveillance systems. More particularly, the present invention relates to a portable speed limit video radar for capturing speed limit violations.

Surveillance systems may be deployed to maintain road safety and avoid accidents by recording speed limit violations. On private property such as a gated community, one approach to implementing a surveillance system is to hire an outside security contractor, who may patrol or monitor roadways in a patrol vehicle or on foot. However, this security contractor may become an uncomfortable presence within the community, intruding on residents' personal privacy and space. Moreover, the costs of retaining the security contractor may be significant, and disputes between the security contractor and residents may add further financial and administrative burdens.

A less onerous self-policing solution may then be desirable. One approach is to use automated surveillance systems, such as speed cameras. However, many of these systems require elaborate setup and installation, which may require these systems to be fixed to a particular location. In many cases, a stationary surveillance system does not meet the evolving requirements of its users. Motorists may also become acclimated to the fixed location of the surveillance systems, resulting in a lost speed deterrent effect.

While portable speed cameras are known in the art, existing approaches suffer from several drawbacks. One approach requires tethering to a vehicle, such as in the back seat of a stationary van, which may be impractical and somewhat conspicuous. Another approach is a handheld speed camera, which requires a human operator and cannot be used for unattended operation. Yet another approach simply combines off-the-shelf parts together, such as a camera and a radar, in an open-air setup. However, this ad-hoc solution is unwieldy and requires careful setup and dismantling. Further, equipment theft, vandalism, and exposure to weather becomes a significant concern.

As can be seen, there is a need for an improved way to capture speed limit violations.

### SUMMARY OF THE INVENTION

In one aspect of the present invention, a portable enclosure provides a speed limit video radar, the portable enclosure including: a rechargeable battery; a processor; a network module; a camera; and a radar. The rechargeable battery supplies power to the processor, the network module, the camera, and the radar. The processor is configured to: detect, using the radar, an estimated speed of a vehicle; determine that the estimated speed of the vehicle exceeds a predetermined speed limit; capture, using the camera, one or more video frames of the vehicle, wherein the one or more video frames each include a present time and the estimated speed of the vehicle; and upload, using the network module, the one or more video frames to a storage.

In another aspect of the present invention, a method for capturing speed limit violations using a portable enclosure is provided, the method including: detecting, using a radar, an estimated speed of a vehicle; determining that the estimated speed of the vehicle exceeds a predetermined speed limit; capturing, using a camera, one or more video frames of the vehicle, wherein the one or more video frames each include a present time and the estimated speed of the vehicle; and uploading, using a network module, the one or more video frames to a storage; wherein the radar, the camera, and the network module are included in the portable enclosure.

In a further aspect of the present invention, a non-transitory computer readable medium stores one or more instructions that, when executed by one or more processors, cause: detecting, using a radar, an estimated speed of a vehicle; determining that the estimated speed of the vehicle exceeds a predetermined speed limit; capturing, using a camera, one or more video frames of the vehicle, wherein the one or more video frames each include a present time and the estimated speed of the vehicle; and uploading, using a network module, the one or more video frames to a storage; wherein the radar, the camera, and the network module are included in a portable enclosure.

These and other features, aspects and advantages of the present invention will become better understood with reference to the following drawings, description and claims.

### BRIEF DESCRIPTION OF THE DRAWINGS

FIG. 1A is a side view of an exemplary portable enclosure providing a speed limit video radar, according to an embodiment of the present invention;

FIG. 1B is a front view of an exemplary portable enclosure providing a speed limit video radar, according to an embodiment of the present invention;

FIG. 1C is a block diagram of components in an exemplary portable enclosure providing a speed limit video radar, according to an embodiment of the present invention;

FIG. 2 is a flowchart of an exemplary method for capturing speed limit violations using a portable enclosure, according to an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, this invention relates to providing a portable enclosure for a speed limit video radar. Several parts are integrated into a single portable enclosure, which may include a camera, a radar, a network module, a rechargeable battery and one or more processors. The portable enclosure may be mountable to a standard tripod. The network module may connect to a cellular network to upload video footage of potential violations into a centralized remote cloud storage. Optionally, a GPS receiver may be integrated to provide device location tracking and geotagging. For device management and configuration, the network module may expose a wireless network, which may connected to using a mobile device such as a smartphone or tablet.

The portable enclosure provides several advantages. Since the portable enclosure includes a rechargeable battery, the electronics in the portable enclosure can operate without access to AC grid power, greatly increasing placement flexibility. To extend the operational time of the portable enclosure, the portable enclosure may also be connected to an external DC power source such as an external battery. Of course, if AC grid power is available, then an AC-DC adapter may also be utilized.

Due to the compact and convenient form factor of the portable enclosure, which may include a suitcase form factor with an integrated handle, transport and deployment of the portable enclosure is greatly facilitated. The portable enclosure may include a quick release mounting mechanism for a standard tripod, allowing quick repositioning for an optimal vantage point to capture speed limit violations. The compact and regular shape of the portable enclosure may also facilitate the application of camouflage materials to provide a discreet surveillance system. Protective outer materials of the portable enclosure may shield inside components from outside elements, such as inclement weather. The portable enclosure may also be tied to a fixed object, such as a pole or tree, using a lock and chain or another securing mechanism, thereby deterring theft and tampering.

Since the video footage of the possible violations are uploaded to remote storage using a network module, such as a cellular modem, no on-board storage of videos is required. Further, physical tampering or destroying of video evidence is not possible after the uploading is completed. With an optional GPS receiver, the real-time location of the portable enclosure can be tracked and remote notifications may be sent if GPS coordinates change, which may assist in recovery from theft or tampering. If multiple speed limit radars are deployed, then the GPS receivers may allow the user to visualize the location of the speed limit radars on a map. The uploaded video footage may also be geotagged using location data provided by the GPS receiver, providing high quality evidence to substantiate a speed limit violation. To preserve battery life and to reduce cellular data usage, the videos may be captured at a lower framerate than a standard video (e.g. 24 to 30 frames per second), such as approximately 5 to 10 frames per second, but with sufficient picture quality to legibly read a license plate. Optionally, an infrared night vision mode may be supported to capture in low light conditions, such as during night time.

Since device management and configuration can be accomplished by connecting to a wireless network exposed by the network module, the user is enabled to easily manage the device using a tablet, smartphone, or other wireless enabled device that the user is already carrying and familiar with. For example, a web browser based configuration interface may be presented to the user, allowing the user to use any standard web browser to configure the portable enclosure. The portable enclosure can thus advantageously omit any user interface components such as physical switches, display screens, keypads, and other parts, leaving more space for a larger battery or other components. Thus, the user can easily adjust the aim of the camera and radar, change predetermined speed limit thresholds for triggering violations, and adjust other parameters as necessary.

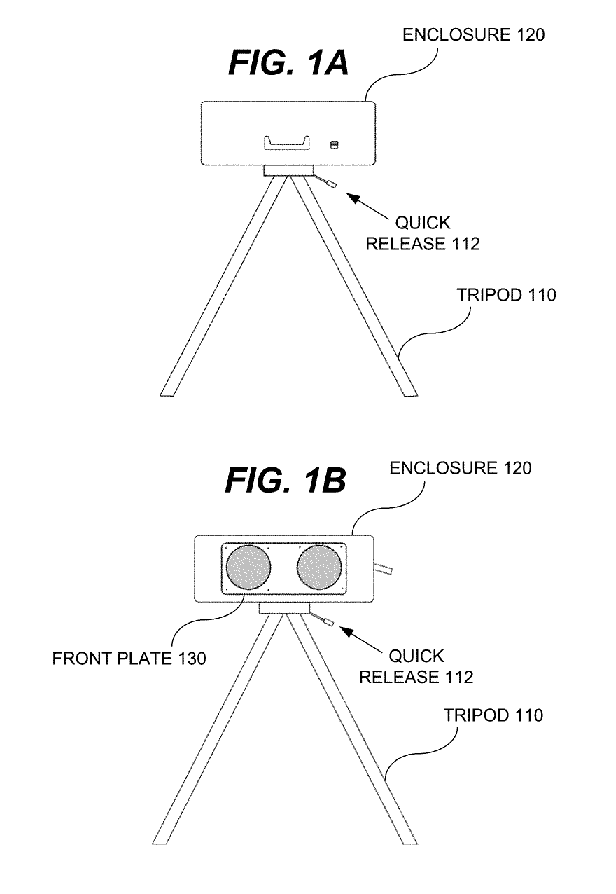

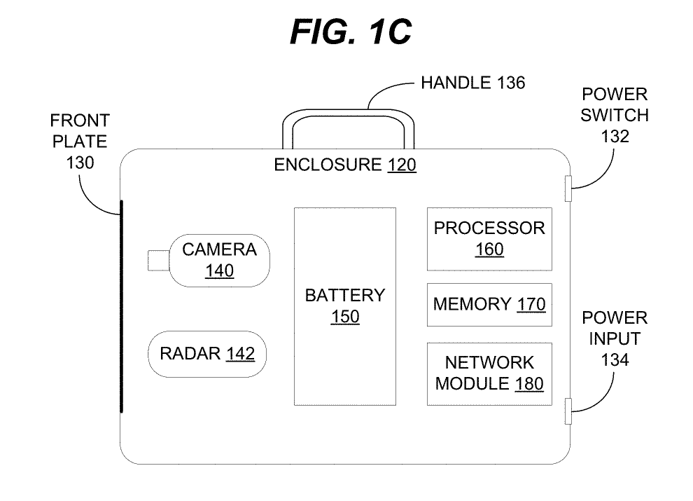

FIG. 1A is a side view of an exemplary portable enclosure providing a speed limit video radar, according to an embodiment of the present invention. FIG. 1A includes tripod 110, quick release 112, and enclosure 120.

As shown in FIG. 1A, enclosure 120 may adopt a suitcase form factor with an integrated handle. An example existing commercial case that may be adapted for enclosure 120 may include equipment cases manufactured by the Pelican™ brand. In other embodiments, a custom case may be manufactured. A quick release 112 may allow enclosure 120 to be rapidly mounted and dismounted from tripod 110, which may be a standard camera tripod.

FIG. 1B is a front view of an exemplary portable enclosure providing a speed limit video radar, according to an embodiment of the present invention. FIG. 1B includes tripod 110, quick release 112, enclosure 120, and front plate 130. With respect to FIG. 1B, like numbered elements may refer to the same elements from FIG. 1A.

As shown in FIG. 1B, the front face of enclosure 120 includes a front place 130, which includes cutouts for a camera and a radar, as described further in conjunction with FIG. 1C. The cutouts may be, for example, transparent or semi-transparent glass, plastic, or any other see-through material. In some embodiments, the cutouts may expose the lens of the camera and the radar directly outside enclosure 120 without any covering.

As described above, the compact and regular form factor of enclosure 120 may facilitate the application of camouflage materials. For example, since enclosure 120 is a rectangular suitcase form factor, a camouflage cover may be readily applied to partially cover enclosure 120 while avoiding the cutouts of front plate 130. A similar camouflage cover may also be applied to the legs of tripod 110.

With an overview of enclosure 120 now established, turning to FIG. 1C, FIG. 1C is a block diagram of components in an exemplary portable enclosure providing a speed limit video radar, according to an embodiment of the present invention. Enclosure 120 of FIG. 1C includes front plate 130, power switch 132, power input 134, handle 136, camera 140, radar 142, battery 150, processor 160, memory 170, and network module 180. With respect to FIG. 1C, like numbered elements may refer to the same elements from FIG. 1A and FIG. 1B.

As shown in FIG. 1C, enclosure 120 integrates several different parts to provide an all-in-one speed limit video radar. Camera 140 may comprise a conventional video camera. Optionally, camera 140 may be equipped with low light infrared video capture functionality, in which case an additional infrared illuminator may be coupled to camera 140 (not shown). Radar 142 may comprise a conventional speed radar, for example a radar that utilizes Kₐ bands for detection. Front plate 130 may include circular transparent or semi-transparent cutouts, as shown in FIG. 1B, allowing camera 140 and radar 142 to operate normally despite being enclosed in enclosure 120. Handle 136 may correspond to a carrying handle, which may fixed or configured to be foldable, retractable, and/or detachable.

Battery 150 may comprise a standard rechargeable battery, such as a gel cell battery, lead acid battery, or lithium ion cell pack. As shown in FIG. 1C, battery 150 may be disposed substantially in the middle of enclosure 120. Since battery 150 may be quite large and heavy, this may help to provide a better balance of gravity for enclosure 120. Charge protection PCBs and one or more DC-DC power converters, which are not shown in FIG. 1C, may also be utilized to manage charging of battery 150 and provide various required DC voltages to components within enclosure 120, including camera 140, radar 142, processor 160, memory 170, and network module 180. Battery 150 may be recharged from DC power provided at power input 134. Power switch 132 may control the flow of power from battery 150 and/or power input 134 to the components in enclosure 120. In some embodiments, besides power on and off, power switch 132 may also provide a selection of high performance and battery saver modes to provide user controlled power management. The presence or absence of power from power input 134 may also change power management settings.

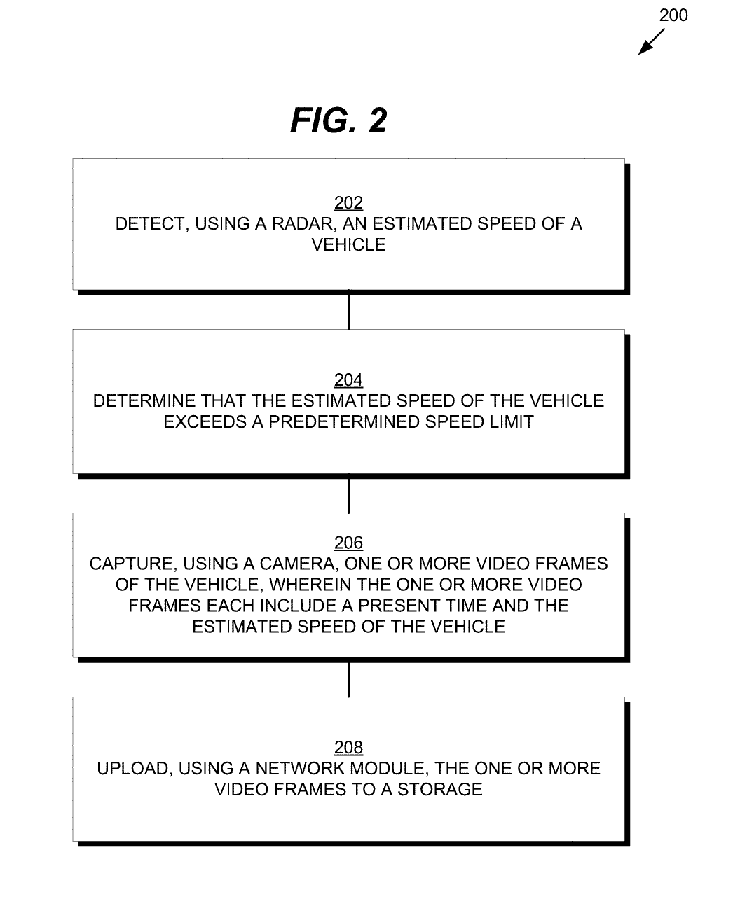

Processor 160 may comprise a general purpose computer processor with one or more cores. In embodiments, processor 160 may include one or more general purpose processors, system on a chip, ASICs, FPGAs, microcontrollers, single board computers, or any other suitable computing device. In an example, processor 160 may correspond to a Raspberry Pi. Memory 170 may comprise any suitable volatile and/or or non-volatile memory, including flash memory. Processor 160 may execute one or more instructions stored in memory 170 to interface with and control camera 140, radar 142, and network module 180, as described in further detail below in conjunction with FIG. 2.

Now that the details of the components within the portable enclosure have been described, turning to FIG. 2, FIG. 2 is a flowchart of an exemplary method for capturing speed limit violations using a portable enclosure, according to an embodiment of the present invention. Process 200 includes block 202, block 204, block 206, and block 208.

With reference to FIG. 1C, at block 202, processor 160 detects, using radar 142, an estimated speed of a vehicle. For example, enclosure 120 may be oriented such that radar 142 is focused on the rear side of vehicles as they pass by on a lane of a road. Initial large adjustments of camera 140 and radar 142 may be accomplished by moving and placing an attached tripod, as shown in FIG. 1A and 1B. Final fine aiming adjustments of camera 140 and radar 142 may be setup using a tablet, smartphone, or other device via an administrative interface provided by network module 180, as discussed further below. These fine aiming adjustments may include camera and radar parameters such as zoom, angle, focus, ISO level, radio frequency band, and others. Once radar 142 detects motion from a vehicle, then radar 142 may determine an estimated speed of the vehicle using known methods in the art.

With reference to FIG. 1C, at block 204, processor 160 determines that the estimated speed determined in block 202 exceeds a predetermined speed limit. As discussed above, this predetermined speed limit may be configured by the user by utilizing a configuration webpage accessible via a wireless network broadcasted by network module 180. For example, network module 180 may broadcast a Wi-Fi SSID, allowing any Wi-Fi capable device, such as a tablet or smartphone, to connect and configure network module 180. Security and authentication protocols may be implemented to validate the user as a known administrator, as known in the art. If the estimated speed does not exceed the predetermined speed limit, then process 200 may end at block 204. In some embodiments, multiple speed limit thresholds may also be detected instead of a single predetermined speed limit. In this manner, the user can analyze vehicle speeding events that fall within certain ranges, according to the user's specific monitoring needs.

With reference to FIG. 1C, at block 206, processor 160 captures, using camera 140, one or more video frames of the vehicle, wherein the one or more video frames each include a present time and the estimated speed of the vehicle determined in block 202. The present time may be retrieved from a local real-time clock, remotely from a time synchronization server, or from a GPS signal or other time synchronization signal. Further, the video frames may also include a user-defined location name associated with enclosure 120, such as a road or street name, coordinates, intersection, or other description. The present time, estimated speed, and user-defined location, for example “Street ABC”, may be overlaid as text subtitles visible within the video frames. If a GPS receiver is present, then the video frames may be tagged, or geotagged with location information embedded within the video frames, to help provide stronger evidence.

As discussed above, the framerate for the video may be much lower than a typical video, for example approximately 5-10 frames per second. This may help to conserve cellular network data allocations and reduce the total storage burden while still providing sufficient evidence of a speed violation. However, in some embodiments, a higher framerate video may be captured, for example if cellular data usage limits are not a concern. Further, in some embodiments, block 206 may be carried out continuously to capture a video stream, rather than discrete speeding events triggered by block 202.

As discussed above, camera 140 may optionally support a low-light capture mode using infrared. In this case, when camera 140 detects a low-light condition, processor 160 may turn on an infrared illuminator, such as an infrared LED array, and capture the one or more video frames in an infrared mode. The low-light condition may be detected using a light sensor or based on the present time. The infrared illuminator may only be triggered during the capture to conserve battery life.

With reference to FIG. 1C, at block 208, processor 160 uploads, using network module 180, the one or more video frames from block 206 to a storage. As discussed above, network module 180 may connect to a cellular network. Thus, cellular module 180 may include a 3G, 4G/LTE, or other type of cellular data modem. The storage may be a remote cloud storage server.

Accordingly, a user can easily observe any detected speed violations by connecting to the cloud storage server, which may present a web-based or application-based interface for viewing violations, saving images or videos, or printing tickets or notices. While the videos may actually be stored as separate independent image frames, the interface may provide the capability to view and generate a video file by combining the video frames into a continuous video, which may be done in real-time or provided as a rendered video file. If multiple enclosure 120s are deployed, then the videos may be sorted according to GPS location and displayed on a map, or sorted by user-defined location name. Alternatively, the user may directly access the file system of the cloud storage server, which may be organized using bookmarks and/or folders according to speed, location, and other criteria.

As discussed above, network module 180 may also be configured to broadcast a wireless network, such as a Wi-Fi network, to enable administration and setup of enclosure 120 by the user. Thus, the user can set one or more predetermined speed limits or thresholds, a user-defined location name, and the aiming of camera 140 and radar 142. The strength of the wireless signal may be such that the user can access the network from within approximately 30 feet of enclosure 120.

It should be noted that the present invention as described above can also be embodied in the form of one or more computer readable instructions embodied in tangible media, such as floppy disks, CD-ROMs, DVD-ROMs, flash storage, hard drives, or any other non-transitory computer-readable storage medium, wherein, when the one or more computer readable instructions are loaded into and executed by a computer, the computer becomes an apparatus for practicing the invention. The computer may include one or more processors coupled to a memory containing the one or more computer readable instructions.

It should be understood, of course, that the foregoing relates to exemplary embodiments of the invention and that modifications may be made without departing from the spirit and scope of the invention as set forth in the following claims.

We claim:

1. A portable enclosure providing a speed limit video radar, the portable enclosure comprising: a rechargeable battery; a processor; a network module; a camera; and a radar;
wherein the rechargeable battery supplies power to the processor, the network module, the camera, and the radar; and
wherein the processor is configured to:
detect, using the radar, an estimated speed of a vehicle;
determine that the estimated speed of the vehicle exceeds a predetermined speed limit;
capture, using the camera, one or more video frames of the vehicle, wherein the one or more video frames each include a present time and the estimated speed of the vehicle; and
upload, using the network module, the one or more video frames to a storage.

2. The portable enclosure of claim 1, wherein the portable enclosure is a suitcase form factor with an integrated handle, wherein the portable enclosure is mountable to a tripod, and wherein the rechargeable battery is disposed substantially in a center of the portable enclosure.

3. The portable enclosure of claim 1, wherein the portable enclosure further includes a GPS receiver, and wherein the one or more video frames are tagged with a location retrieved from the GPS receiver.

4. The portable enclosure of claim 1, wherein the camera enters into an infrared capture mode that utilizes an infrared illuminator when the camera detects a low light condition.

5. The portable enclosure of claim 1, wherein the network module is configured to broadcast a wireless network for configuring the portable enclosure, the configuring including one of: setting the predetermined speed limit, setting a location name, and aiming the camera and the radar.

6. The portable enclosure of claim 1, wherein the network module is configured to connect to a cellular network to upload to the storage.

7. The portable enclosure of claim 1, wherein the portable enclosure is partially covered with camouflage materials.

8. A method for capturing speed limit violations, the method comprising:
detecting, using a radar, an estimated speed of a vehicle;
determining that the estimated speed of the vehicle exceeds a predetermined speed limit;
capturing, using a camera, one or more video frames of the vehicle, wherein the one or more video frames each include a present time and the estimated speed of the vehicle; and
uploading, using a network module, the one or more video frames to a storage;
wherein the radar, the camera, and the network module are included in a portable enclosure.

9. The method of claim 8, wherein the enclosure further includes a GPS receiver, and wherein the one or more video frames are tagged with a location retrieved from the GPS receiver.

10. The method of claim 8, wherein the camera enters into an infrared capture mode that utilizes an infrared illuminator when the camera determines a low light condition.

11. The method of claim 8, further comprising:
broadcasting, using the network module, a wireless network for configuring the portable enclosure, the configuring including one of: setting the predetermined speed limit, setting a location name, and aiming the camera and the radar.

12. The method of claim 8, wherein the network module is configured to connect to a cellular network to upload to the storage.

13. The method of claim 8, wherein the portable enclosure is partially covered with camouflage materials.

14. A non-transitory computer readable medium storing one or more instructions that, when executed by one or more processors, cause:
detecting, using a radar, an estimated speed of a vehicle;
determining that the estimated speed of the vehicle exceeds a predetermined speed limit;
capturing, using a camera, one or more video frames of the vehicle, wherein the one or more video frames each include a present time and the estimated speed of the vehicle; and
uploading, using a network module, the one or more video frames to a storage;
wherein the radar, the camera, and the network module are included in a portable enclosure.

15. The non-transitory computer readable medium of claim 14, wherein the portable enclosure is a suitcase form factor with an integrated handle, wherein the portable enclosure is mountable to a tripod, and wherein a rechargeable battery is disposed substantially in a center of the portable enclosure.

16. The non-transitory computer readable medium of claim 14, wherein the portable enclosure further includes a GPS receiver, and wherein the capturing further tags the one or more video frames with a location retrieved from the GPS receiver.

17. The non-transitory computer readable medium of claim 14, wherein the camera enters into an infrared capture mode that utilizes an infrared illuminator when the camera detects a low light condition.

18. The non-transitory computer readable medium of claim 14, wherein the network module is configured to broadcast a wireless network for configuring the portable enclosure, the configuring including one of: setting the predetermined speed limit, setting a location name, and aiming the camera and the radar.

19. The non-transitory computer readable medium of claim 14, wherein the network module is configured to connect to a cellular network to upload to the storage.

20. The non-transitory computer readable medium of claim 14, wherein the portable enclosure is partially covered with camouflage materials.
